(19) United States
(12) Patent Application Publication
(10) Pub. No.: US 2006/0156590 A1
(43) Pub. Date: Jul. 20, 2006

(54) Tree root pruning apparatus and method of use

(75) Inventor: Wayne P. Capolupo, Salisbury, MA (US)

Correspondence Address: Law Offices of Michael Leccese;Michael Leccese, Esq., Suite 202, 790 Turnpike St., North Andover, MA, 01845, US

(73) Assignee: SPS New England, Inc., Salisbury, MA (US)

(21) Appl. No.: 11/036,836

(22) Filed: Jan. 14, 2005

(51) Int. Cl. A01C 11/00; A01G 23/02; A01B 13/00; A01G 23/06

(52) U.S. Cl. 37/302

(57) ABSTRACT

An apparatus and method of root pruning a woody plant having a main trunk and usually a distinct crown, such as a tree. More particularly, the invention relates to an apparatus and manner in which to prune root systems of trees, in preparation of transplantation or while excavating in proximity to a tree, more efficiently and effectively than in the past. The invention includes among its essential elements a vibratory apparatus coupled to a mobile device. The mobile device may be an excavator machine having an articulated machine arm with the root pruning vibratory apparatus attached thereto. The machine's articulated arm positions the vibratory apparatus in a desired location while applying force to the apparatus, pushing it into the ground while the apparatus is vibrating, penetrating the blade into the ground or, optionally, the vibratory apparatus having the ability to provide a hammering action. The vibratory apparatus has at least a lower member and an upper member, the lower member capable of vibrating and the upper member adapted to be removably attached to the mobile device. The vibratory lower member is capable of accepting a blade mounting member. The blade mounting member is adapted for ground penetration when placed in contact with the ground, capable of cutting cleanly through tree roots during ground penetration.

### FIELD

The invention relates generally to a ground penetrating root pruning apparatus and method of using the same, more particularly an improved vibratory blade apparatus and method of use which results in efficient ground penetration and clean severing of woody plant roots minimizing ripping or tearing of roots.

### BACKGROUND

In the past, excavating in proximity to trees resulted in breaking, tearing and, generally, damaging the tree root system. Excavating near a tree, preparing the tree for transplantation, or digging in proximity to a tree for other construction purposes including but not limited to laying pipe or wire or for other underground motivations was accomplished by several techniques. Frequently, in excavating proximately to a tree, the ground penetrating device will come in contact with the tree root or a tree root system, possibly damaging the roots, and making it difficult to trench or dig. This root damage may be in form of ripping or tearing of the tree root. This tree root damage may kill or damage a tree. When excavating in proximity to a tree, root damage is almost unavoidable. When excavating near a tree for construction purposes or preparing the tree for transplantation by removing soil from the base of the tree, the goal is to keep the tree as healthy as possible and one way to do this is to minimize the amount of damage to the tree root system. The least amount of shredded or torn roots will provide the greatest likelihood of ultimate tree survival.

Excavating near a tree for the purpose of extracting a tree from the ground or trenching near a tree without damaging the tree roots can be a difficult task. Tree roots can become damaged, resulting in permanent damage and even death of the tree. Tree transplantation and near tree excavating is common and is well known within the arts. In many circumstances transplanting a tree from one location to another location is desirable. Among the reasons are: a tree grown from a seedling can take a great deal of time, some trees are rare and difficult to replace. However, larger transplanted trees are highly susceptible to shock from the reduced root structure inherent to the transplantation process. This can be mitigated by root pruning one or more growing seasons in advance of the transplantation process which gives the tree an opportunity to acclimate to the reduced root canopy in advance of the move. Typically ⅓ of the perimeter of the tree is pruned in each of the two years prior to the move leaving only ⅓ of the root perimeter freshly cut at the time of the move.

One way known in the arts to transplant a tree is to excavate around the tree to free the roots from the ground then to lift the tree out of the ground. Excavating will remove dirt and associated materials from around the tree, allowing the tree to be moved. Excavation in proximity to trees is common in preparing for the laying of pipe or wire and in other construction activities. In the arts, excavating materials from around or near the tree may vary in scope and in methods of digging. Excavating can be accomplished by many different techniques, one of which is by using a hand-held shovel wherein a person digs a trench around the tree by hand without the use of mechanized equipment. Another way to excavate is by using a shovel machine that typically contains an articulated shovel or bucket arm that is typically operated by a person and is most commonly driven by a powered hydraulic system. These machines are known in the arts as excavators, backhoes or shovels. Yet another prior art used to dig trenches around or near trees is by use of a ditch digging apparatus that contains a large wheel or chain that most likely contains teeth used for removing the ground materials as the wheel or chain rotates. These arts as well as others like these will excavate the ground around the tree and at the same time cut or tear through the tree roots they come in contact with. In all cases one will have difficulty excavating due to having to dig around or through the roots. This action of cutting and tearing of the roots causes damage to the health of the tree.

Other arts common in the tree transplantation technologies involve use of a plurality of spade digger elements typically reciprocally mounted on an extension boom, with the entire assembly attached to a truck, the spade blade being telescopically mounted to a frame typically hydraulically operated via hydraulic cylinders mounted on the frame. Each spade has an up and down motion along a track and can open and close with respect to the other spades. A spade is pushed along the frame contacting the ground in proximity to the tree, penetrating the ground and root system of the tree. The spade is forced or pushed into the ground by the hydraulic cylinder, pushing through the dirt and tearing the tree roots as the spade is forced into the ground. The tree roots are severed by the spade and in most cases the spade rips and tears though the root, potentially damaging the health of the tree. Some arts use a hammering action forcing the spade into the soil. This hammering is usually generated by varying or pulsing the hydraulic pressure in the hydraulic cylinder creating a hammering like effect as the spade is placed in contact with the ground in the desired location in proximity of the tree, thereby creating a pushing hammering action. The spade penetrates into the ground, at the same time forcing its way through the roots when present. This action of forcing a blunt spade into the ground through the tree root system will crush, rip, and tear the tree roots.

### SUMMARY

This invention provides an apparatus and method of efficient woody plant root pruning including, but not limited to, tree roots. More particularly, illustrations of this invention relates to a vibratory apparatus having at least a blade, the blade at least vibrating being in contact with the ground, applying a downward force to the apparatus pushing it such that it contacts the ground, pushing and vibrating the apparatus, the apparatus's blade penetrating into the ground. The vibratory root pruning apparatus providing a vibratory action to the blade, the apparatus also optionally supplying a hammering action to the blade further pushing the blade into the ground, the blade penetrating the ground, the blade cleanly cutting and pruning any roots that the blade comes in contact with. The vibratory apparatus can be fitted with several different kinds of blades such that the vibrator apparatus can be used in many different types of ground conditions. In addition, the invention demonstrates a manner in which to apply and use the vibratory root pruning apparatus: placing the apparatus in proximity to a tree, applying a load pushing it against the ground, penetrating the ground, and pruning roots as it is driven deeper into the ground. In one illustration the blade is substantially perpendicular to the ground as it is being pushed in. This apparatus and use thereof can prune tree roots more efficiently and effectively than in the past. Typically, the vibratory apparatus can be removably attached to a hydraulic equipment excavator arm, front loader or the like. The blade is placed in intimate contact with the ground and pushed against the ground, classically by an articulated hydraulic machine arm while vibrating, as the blade penetrates the ground cutting roots efficiently and effectively using the vibratory action. The vibratory apparatus, once the blade penetrates the ground, can be pulled or pushed along the ground parallel to the ground cutting roots as it contacts them. The blade can be used to prune roots of many different agricultural commodities such as, but not limited to, trees and shrubs. Implementations of this invention include that the vibrating element with blade is mounted to a machine's articulated arm that allows the vibratory element to be placed at the desired location along the tree base.

Using embodiments and implementations of this method will allow the user to root prune woody plants as well as allow for the creation of a preformed path for a wood plant transplanter to subsequently be used more efficiently and effectively. Additionally, illustrations of this device can be used for cleanly cutting roots in proximity to a tree making excavating near the tree more effective and efficient and not having to move the roots or have the roots impair excavation. Furthermore, this invention will supply the necessary apparatus and method to eliminate the need for using additional manual labor efforts once the tree root is unearthed. Using the invention prior to digging the tree roots will result in the roots already having been cleanly cut. Yet another illustration for using this invention is a method that allows for the invention to be used prior to the use of a tree spade transplanter device. The root pruning apparatus can be used in proximity to the tree creating a circumferential ring around the tree where the tree roots are cut cleanly. The spade tree removal equipment can then operate with less effort and less damage to the tree following in approximately the same path, resulting in greatly improved survival rate.

It is a further object of this invention to provide an apparatus and method that is simple by design and efficient in method and use.

Illustrative embodiments and modes of operation of this present invention have been described in this specification. The invention which is intended to be protected herein, however, is not construed as limited to the particular embodiments disclosed, since these embodiments are to be regarded as illustrative rather then restrictive.

### BRIEF DESCRIPTION OF DRAWINGS

Other objects, features, and advantages will occur to those skilled in the art from the following description of an embodiment and the accompanying drawings, figures, illustrations in which:

FIG. 1, shows a perspective view of a vibrating head having a blade mounting member and a blade mounted to a machine articulable equipment arm.

FIG. 2, shows a side view of a vibrating head having a blade mounting member and a blade mounted to an excavator machine articulable equipment arm.

FIG. 3, shows a side view of a vibrating head having a blade mounting member and a blade mounted to an excavator machine articulable equipment arm penetrating the ground in proximity to a tree cutting the tree roots.

FIG. 4, shows a perspective view of a vibrating head having a blade mounting member and a blade mounted to a loader machine equipment arm.

FIG. 5, shows a side view of a blade and a blade mounting member.

FIG. 6, shows a front view of a blade and a blade mounting member.

FIG. 7, shows a side view of a blade and a blade mounting member.

FIG. 8, shows a front view of a blade and a blade mounting member.

FIG. 9, shows a side view of a blade and a blade mounting member.

FIG. 10, shows a front view of a blade and a blade mounting member.

FIG. 11, shows a perspective view of a sharp edged blade and blade mounting member.

FIG. 12, shows a perspective view of a blunt edged blade and blade mounting member.

FIG. 13, shows a perspective view of a serrated edged blade and blade mounting member.

FIG. 14, shows a perspective view of a sharp edged blade and blade mounting member.

FIG. 15, shows a front, side and perspective view of a convex spade shaped blade and blade mounting member.

### DETAILED DESCRIPTION

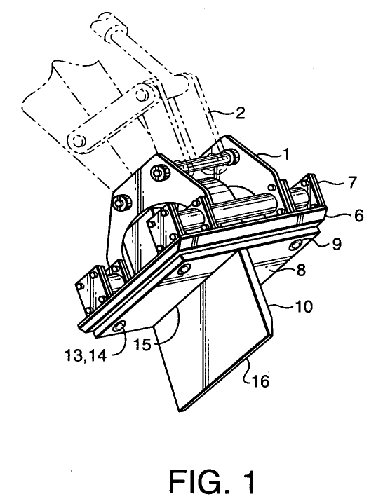

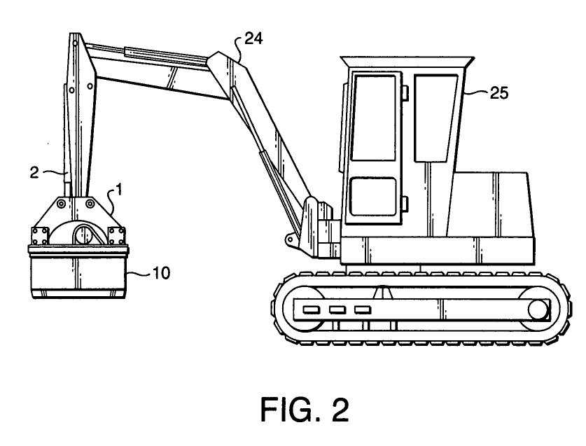

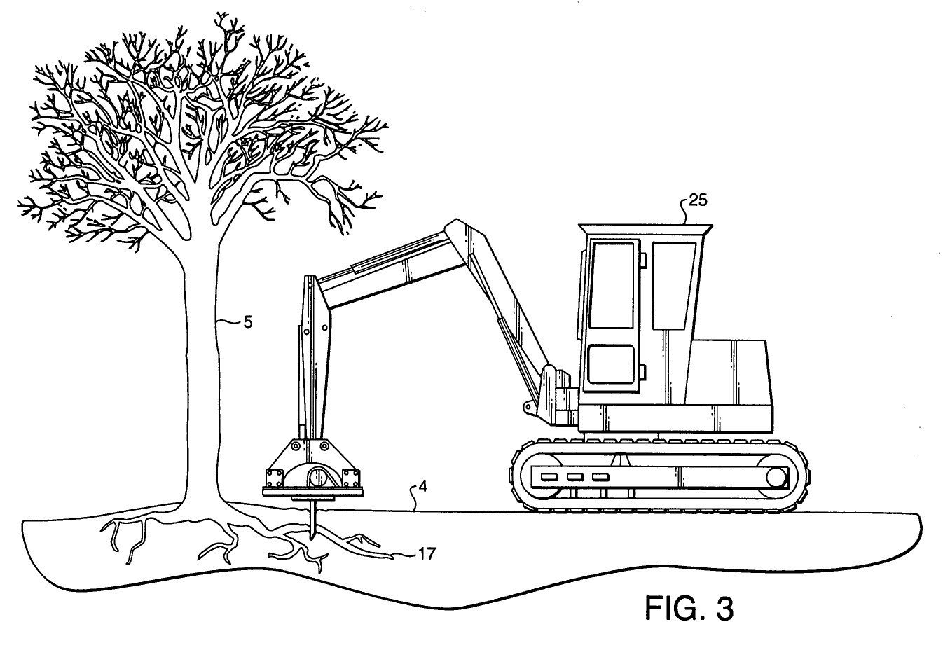

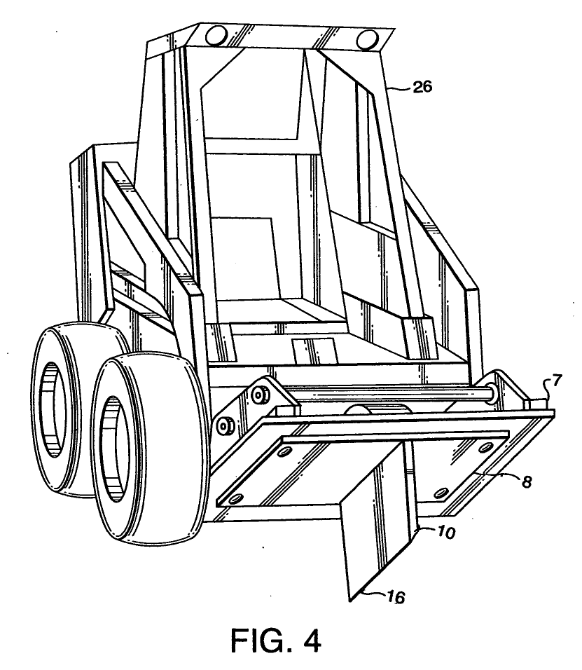

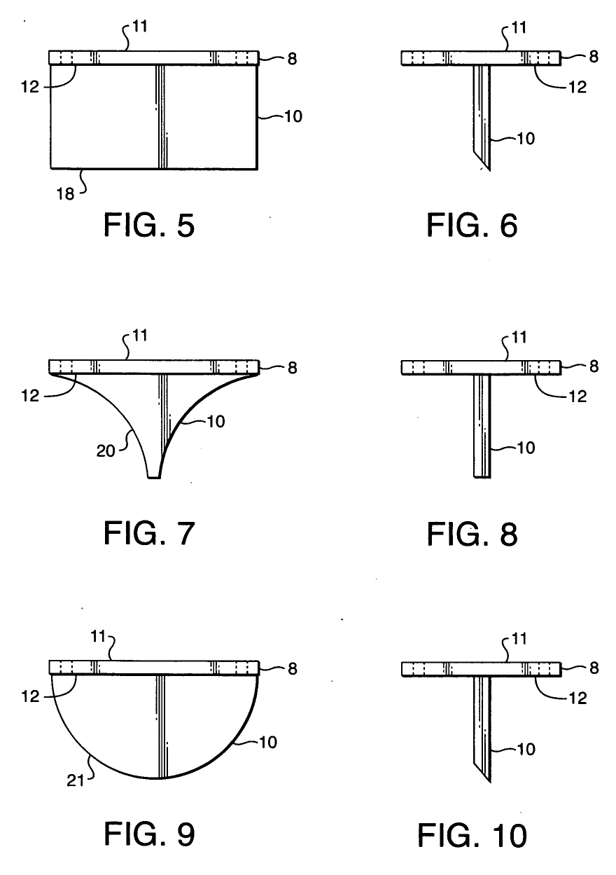

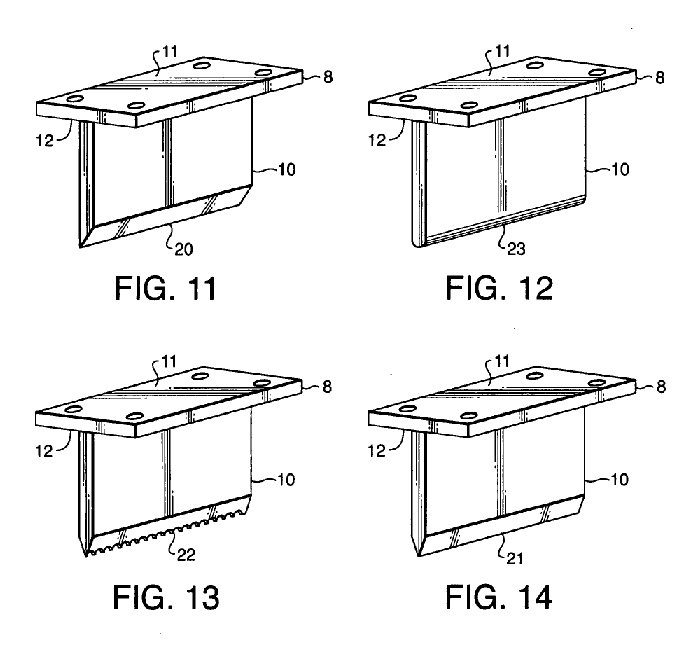

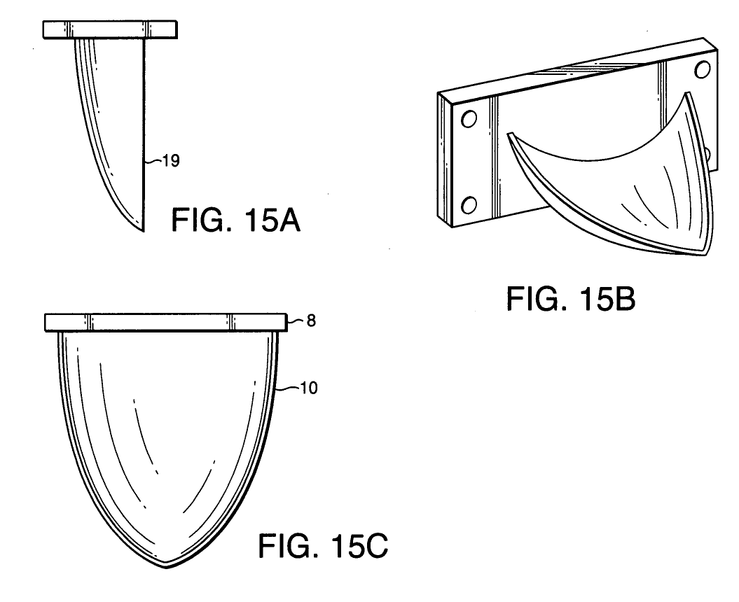

There is shown in FIGS. 1 through 16 an illustrated root pruning device: a root pruning system comprising a vibratory apparatus 1 coupled to a mobile device articulable machine arm 2; the vibratory apparatus 1 root pruner for penetrating the ground 4 in proximity to a woody plant having a main trunk and usually a distinct crown, also know as a tree 5; the vibratory apparatus 1 having at least a lower member 6 and an upper member 7 perhaps attached to a mobile device articulating machine arm 2; the lower member 6 capable of vibrating, the upper member 7 adapted to be removably attached to a mobile device 2; the lower member 6 intended to come in contact with the soil 4 selected in the root pruning operation; the vibratory lower member 6 capable of accepting a blade mounting member 8 perhaps having holes 9 such that the mounting member with blade 10 can be attached the lower vibrating member 6; and the blade mounting member 8 having a first surface 11 and a second surface 12, the first surface 11 arranged to be removably attached to the lower vibratory member 6 and the second surface 12 having a blade 10 fixedly attached thereto. In one illustration the attachment of the blade 10 and blade mounting member 8 can be accomplished with bolts 13 or nuts 14 and bolts 13. The blade 10 has an end 15 fixedly attached to the second surface 12 of the blade mounting member 8 and a shaped edge distal to the fixedly attached end 16 adapted for ground 4 penetration, the blade optionally containing a plurality of cutting edges. The blade 10 can be fixedly attached 15 to the blade mounting member 8 by welding. Vibratory apparata 1 typically are made of several essential components, one of which is the mechanism that creates the vibration 7 along with an optional hammering action and the other is a member that vibrates 6. Vibrating apparata used in construction for soil compaction characteristically contain a lower plate member that is placed in contact with the ground while the plate is vibrating, optionally hammering resulting in vibrating, moving and compacting the soil.

Illustrations of the present invention show a blade 10 that penetrates the soil 4 and cleanly severs the tree roots 17 as it is penetrating the soil 4. Different trees 5 and soil 4 conditions may require different shaped blades 10 and blade cutting edges 16. The blade 10 shapes may include, but are not limited to: a flat rectangular blade 18; a convex shaped spade shaped blade 19; a triangular blade 20; a curved blade 21 and others. The cutting edge of the blade 16 may also be selected to accommodate different soil 4 and tree root 17 conditions. These blade edges include, but are not limited to: single sided continuous edge cutting 28; v shaped (double sided) continuous edge 21; serrated edge 22; blunt edge 23; and combinations of the previously stated. The blade 16 can be made from steel or a hard substance that is typically used in cutting applications such as, but not limited to, carbide or carbide toothed.

Finally, the vibratory invention described in this specification is adapted to mount to a variety of excavating and landscaping equipment 25, 26. The root pruning system can be mounted to a hydraulically operated articulated machine arm 24 or, in another illustration, can be adapted to be mounted on a mechanically articulated machine arm.

The excavator or landscaping requirement can be mobile equipment that may include an articulated arm able to be placed in close proximity to a tree 5. Some equipment, but not limiting, is commonly known in the art as excavators 25, backhoe, front loader 26, ditch digger and trencher.

In one embodiment the machine arm 24 is locating the vibrating root pruning apparatus 1 in proximity to a woody plant 5, engaging the root pruning apparatus, vibrating the blade penetrating the ground 4 in proximity to the woody plant 5, the blade 16 penetrating the ground 4 moving deeper and deeper into the ground 4, the blade severing plant roots 17 moving deeper into the ground, removing the root pruner apparatus and locating at the next desired location, and aligning the root pruner apparatus 1 in close proximity to the previous ground penetration. In yet another illustration the mobile machine is able to move the root pruning apparatus along the ground.

In another illustration the mobile equipment 25, 26 can be equipped with an articulated machine arm 24, to which the root pruner apparatus 1 can be removably attached. Movement of the machine arm 24 or movement of the machine 25 can push or drag the root pruner system 1 along the ground 4 to further prune roots 17.

What is claimed is:

1. A root pruning system comprising:
a vibratory apparatus coupled to,
a mobile device, the vibratory apparatus root pruner for penetrating the ground in proximity to a woody plant having a main trunk and usually a distinct crown, the vibratory apparatus having at least a lower member and an upper member, the lower member capable of vibrating, the upper member adapted to be removably attached to the mobile device, the vibratory lower member capable of accepting,
a blade mounting member, the blade mounting member having a first surface and a second surface, the first surface arranged to be removably attached to the lower vibratory member, the second surface having,
a blade fixedly attached thereto, the blade having an end fixedly attached to the second surface of the blade mounting member and a shaped edge distal to the fixedly attached end adapted for ground penetration.

2. The root pruning system of claim 1 wherein the vibrating lower member is a plate.

3. The root pruning system of claim 1 wherein the blade shaped edge has a continuous edge.

4. The root pruning system of claim 1 wherein the blade shape edge is serrated.

5. The root pruning system of claim 1 wherein the blade is fixably attached to the blade mounting member by welding.

6. The root pruning system of claim 1 wherein the system is adapted to be mounted to a hydraulically operated articulated machine arm.

7. The root pruning system of claim 1 wherein the system is adapted to be mounted on a mechanically articulated machine arm.

8. The root pruning system of claim 1 wherein the blade mounting member being removably attached is attached by at least nuts and bolts.

9. The root pruning system of claim 1 wherein the blade is convex shape.

10. The root pruning system of claim 1 wherein the blade material is steel.

11. The root pruning system of claim 1 wherein the mobile device includes an articulated arm.

12. The root pruning system of claim 1 wherein the mobile device is a machine excavator.

13. The root pruning system of claim 1 wherein the mobile device is a backhoe.

14. The root pruning system of claim 1 wherein the mobile device is a front loader.

15. The root pruning system of claim 1 wherein the blade has a carbide edge.

16. The root pruning system of claim 1 wherein the blade has carbide teeth.

17. The root pruning system of claim 1 wherein the blade has a plurality of cutting edges

18. The root pruning system of claim 1 wherein the vibratory device is a plate soil compactor.

19. The root pruning system of claim 1 wherein the vibratory device is adapted to provide a hammering action.

20. A method of pruning a woody plant having a main trunk and usually a distinct crown comprising the steps of:
attaching removably to a vibratory root pruning system having a vibratory apparatus, a blade mounting member and a blade,
locating a vibrating root pruning apparatus in proximity to a woody plant,
engaging the root pruning apparatus vibrating the blade,
applying a downward force to the vibrating blade pushing the blade into the ground,
penetrating the ground in proximity to the woody plant, the blade penetrating the ground moving deeper and deeper into the ground, the blade
severing plant roots moving deeper into the ground,
moving the root pruning system along the ground,
removing the root pruner apparatus and locating at the next desired location,
aligning the root pruner apparatus in close proximity to the previous ground penetration and repeating engaging the vibratory apparatus with the blade penetrating the ground.

21. The root pruning method of claim 20 wherein the root pruning apparatus penetrating the ground in a plurality of locations creating an annular ring void in the ground around a tree, preforming a path allowing for a spade tree transplanting apparatus to be used in the annular ring void wherein reducing and possibly eliminating the need for the tree spade to sever any roots.
